(19) United States
(12) Patent Application Publication
(10) Pub. No.: US 2026/0318345 A1
(43) Pub. Date: Oct. 15, 2026

(54) WAVE SPRING TORQUE LIMITING HARDWARE

(71) Applicant: Hubbell Incorporated, Shelton, CT (US)

(72) Inventor: Pieter Jere Beckman, Nottingham, NH (US)

(21) Appl. No.: 19/344,832

(22) Filed: Sep. 30, 2025

Related U.S. Application Data
(60) Provisional application No. 63/700,991, filed on Sep. 30, 2024.

(51) Int. Cl. F16B 31/02

(52) U.S. Cl. CPC F16B 31/027

(57) ABSTRACT

A torque limiting apparatus for a rotational mechanical fastener includes a driver head with a spring cavity, dowel pins positioned in recesses in the inner wall of the spring cavity, a shank component inserted into the spring cavity, and an expander wave-spring positioned within the spring cavity around the shank component. The expander wave-spring has ridges extending outward which are in contact with the dowel pins. As the torque limiting apparatus is tightened the dowel pins come in contact with the expander wave-spring ridges, driving the shank component to rotate. As the shank component is further tightened the torque increases, stretching the expander wave-spring out and flattening the ridges. Upon reaching the maximum fastener torque limit, the ridges are flattened enough to allow the dowel pins past each ridge to prevent further tightening the rotational mechanical fastener.

### CROSS-REFERENCE TO RELATED APPLICATION

This application claims the benefit of U.S. Provisional Application No. 63/700,991, filed Sep. 30, 2024, the contents of which is incorporated herein by reference in its entirety.

### FIELD

The present disclosure relates to torque limiting hardware to limit the amount of rotational force used in tightening a threaded mechanical fastener. More particularly, the present disclosure relates to expander wave-spring torque limiting hardware for use in tightening a threaded mechanical fastener.

### BACKGROUND

Fastener torque is the amount of rotational force applied to a fastener during tightening. Proper fastener torque ensures structural integrity and functionality of the fastener. Applying the correct amount of fastener torque to the fastener to tighten it is important to prevent over-tightening or under-tightening. Over-tightening can cause damage to either the item the fastener is being tightened to, or to the fastener itself. Under tightening can result in loose connections, premature failure or damage to the threads of the fastener.

The use of proper fastener torque is important in several respects. It helps to improve performance of the fastener, increases longevity of the fastener and the item to which it is fastened and improves safety by eliminating loose connections. Use of the proper fastener torque also aids in reducing stress and wear on the fastener and increases the service life of the fastener and the item(s) to which it is attached.

Some conventional torque limiting fasteners use a breakaway method in which the head of the fastener is supposed to break off within a predesigned torque value range. In other words, the break-off torque is the rotating force required to break the head off. However, the actual break-off torque values of such breakoff hardware can vary considerably due to variations in material quality, manufacturing processes, temperature (e.g., especially in plastics) or other environmental factors.

### SUMMARY

Various embodiments of the present disclosure aid in overcoming the afore-mentioned disadvantages and other drawbacks associated with conventional torque limiting fasteners and offer new advantages as well. For example, through use of the various embodiments the functionality of the wave-spring torque limiting apparatus can be tested without testing to failure as is required with conventional break-off hardware. Another advantage of the various embodiments disclosed herein is that the torque limit can be altered by switching out the expander wave-spring-e.g., using an expander wave-spring constructed from an alternate material or having a different thickness.

The wave-spring torque limiting apparatus according to the various embodiments can embodied with several different faster head/drive types-e.g., eye, hex, socket, or the like. The various embodiments can be implemented a part of the threaded base (i.e., part of the fastener itself) or can be used as torque limiting attachment that is removed upon tightening the fastener using the proper amount of fastener torque. Further, the various embodiments eliminate the litter and waste produced by conventional metal and plastic non-captive break-off hardware.

According to various embodiments of the present disclosure there is provided an expander wave-spring torque limiting apparatus that includes a driver head with a torque drive section, a spring cavity formed within the driver head that has an inner proximal driver-head surface, a shank component with a proximal shank-end positioned to extend into the spring cavity, a threaded section of the shank component, at least one dowel pin, and a wave-spring element curled around a rotational center line and a number of ridges extending in a radial direction outward from the rotational center line. The wave-spring element is positioned within the spring cavity around the shank component. Applying rotational force to the driver head causes torque to be applied to the shank component.

In some forms of the expander wave-spring torque limiting apparatus the wave-spring element is attached to the shank component. n some forms, the expander wave-spring torque limiting apparatus also includes a number of dowel recesses positioned on an inner surface of the spring cavity. Typically, each of the dowel recesses is shaped to receive a respective one of the dowel pins. In some forms of the expander wave-spring torque limiting apparatus each of the dowel pins is cylindrical Some forms of the expander wave-spring torque limiting apparatus include a number of troughs formed between adjacent ones of the ridges of the wave-spring element.

In some forms of the expander wave-spring torque limiting apparatus the rotational force applied to the driver head is passed to the shank component via the plurality of dowel pins via the wave-spring element.

In some forms of the expander wave-spring torque limiting apparatus the torque drive section is hex shaped, and is sized to be driven by a combination wrench. Typically, the threaded section of the shank component has male threads configured to screw into a female threaded component. In some forms of the expander wave-spring torque limiting apparatus applying clockwise rotational force to the driver head causes the shank component to screw into the female threaded component.

In some forms of the expander wave-spring torque limiting apparatus the proximal shank-end of the shank component rests against the inner proximal driver-head surface in the recess of driver head. Some forms of the expander wave-spring torque limiting apparatus include a first dowel pin and a second dowel pin, a first ridge and a second ridge. The first and second ridges each extend upward from a minimum height to a ridge height. Applying the rotational force to the driver head causes the first dowel pin to push against the first ridge, transferring the rotational force to the shank component.

In some forms of the expander wave-spring torque limiting apparatus the first ridge flattens in response to the rotational force and contact by the first dowel pin. In some forms applying a second rotational force to the shank component causes the first dowel pin to pass by the first ridge, wherein the second rotation force is greater than the first rotational force. The second rotational force is called a maximum fastener torque of the torque limiting apparatus. In some forms removing all rotational force from the shank component causes the first ridge to rise to the ridge height.

In some forms of the expander wave-spring torque limiting apparatus the first rotational force and the second rotational force are applied in a clockwise direction to tighten the threaded section of the shank component. In some forms applying a third rotational force in a counter-clockwise direction results in the first dowel pin coming into contact with the second ridge causing the threaded section of the shank component to loosen.

In some forms, there is a wave-spring torque limiting apparatus for a rotational mechanical fastener that includes a driver head, a shank component, a wave-spring element, a first dowel pin, and a second dowel pin. The driver head includes a spring cavity formed within the driver head. The shank component is disposed within the driver head. The wave-spring element is disposed within the spring cavity and extends at least partially around a perimeter of the shank component. The wave-spring element includes a series of alternating concave regions and convex regions. The wave-spring element includes a fixed end coupled to an outer surface of the shank component and a free end spaced apart from the fixed end. The first dowel pin is disposed in one of the concave regions and the second dowel pin is disposed in another of the concave regions. Applying first rotational force to the driver head in a first rotational direction causes tightening-torque to be applied to the shank component. A radii of curvature of the concave regions and convex regions may increase so that the wave-spring element stretches around the perimeter of the shank component. Applying second rotational force to the driver head in a second rotational direction causes loosening-torque to be applied to the shank component. The radii of curvature of the concave regions and convex regions may decrease so that the free end moves away from the fixed end of the wave-spring element.

In some forms, there is a wave-spring torque limiting apparatus for a rotational mechanical fastener that includes a shank component coupled to a driver head, a dowel disposed within a cavity of the driver head, and a wave-spring element disposed within the cavity between the shank component and the dowel. The wave-spring element having a first end fixed to the shank component and a second end spaced apart from the fixed end around a perimeter of the shank component. The wave-spring element is movable between a first position that can distribute a tightening torque to the shank component and a second position that can limit the tightening torque being applied to the wave-spring element. A spacing between the first end and the second end decreases as the wave-spring element moves between the first position and the second position.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is an exploded perspective view of expander wave-spring wave-spring torque limiting hardware for a threaded mechanical fastener according to various embodiments disclosed herein.

FIGS. 2-3 are perspective views of expander wave-spring torque limiting hardware for a threaded mechanical fastener according to various embodiments disclosed herein.

FIG 5. 4A-B are cross-sectional views of expander wave-spring torque limiting hardware for a threaded mechanical fastener according to various embodiments disclosed herein.

FIGS. 5A-C are cross-sectional top views of an expander wave-spring torque limiting hardware for a threaded mechanical fastener according to various embodiments disclosed herein.

### DETAILED DESCRIPTIONS

The figures depict a presently preferred embodiment of expander wave-spring torque limiting hardware for a threaded mechanical fastener. As depicted, the various embodiments are configured for use as expander wave-spring torque limiting hardware that ensures the proper amount of rotational force is used to tighten a threaded fastener.

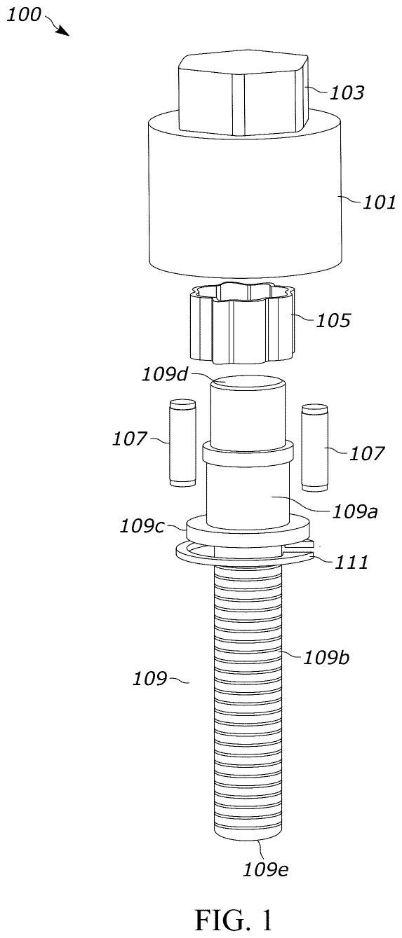

FIG. 1 is an exploded perspective view of expander wave-spring torque limiting hardware for a threaded mechanical fastener 100 according to various embodiments disclosed herein. The expander wave-spring torque limiting hardware includes a driver head 101, an expander wave-spring 105, dowel pins 107, and the threaded mechanical fastener 100 includes a shank component 109.

The driver head 101 is configured with a torque drive section 103. Typically, the torque drive section 103 is shaped to allow insertion (or application) and removal of a tool that provides leverage for tightening and loosening the expander wave-spring torque limiting hardware. The torque drive section 103 depicted in FIG. 1 is hex shaped, and may be sized to be driven by a type of mechanic's wrench—e.g., a combination wrench, box end wrench, socket wrench, etc.—or may be driven by an adjustable wrench such as pliers, an adjustable groove joint wrench, or the like. The torque drive section 103 may be configured to use other types of wrenches or drivers such as a hex wrench, a square driver, a torx driver, a slotted or phillips head screw driver, a spanner driver, or other like types of rotational drivers known to those of ordinary skill in the art.

The shank component 109 is typically configured with a spring shaft section 109a, a threaded section 109b, and a spring support ledge 109c. The spring shaft section 109a extends upward from the spring support ledge 109c towards a proximal end 109d of shank component 109. The cylindrical-expander wave-spring 105 fits around the spring shaft section 109a. The height of the spring shaft section 109a is greater than the width of expander wave-spring 105 by at least a small amount—e.g., at least 1/32 of an inch-to avoid excess friction between expander wave-spring 105 and the spring support ledge 109c. The cylindrical-expander wave-spring 105 may also sometimes be called a Marcel expander wave spring 105. For brevity it can be called an expander wave-spring 105.

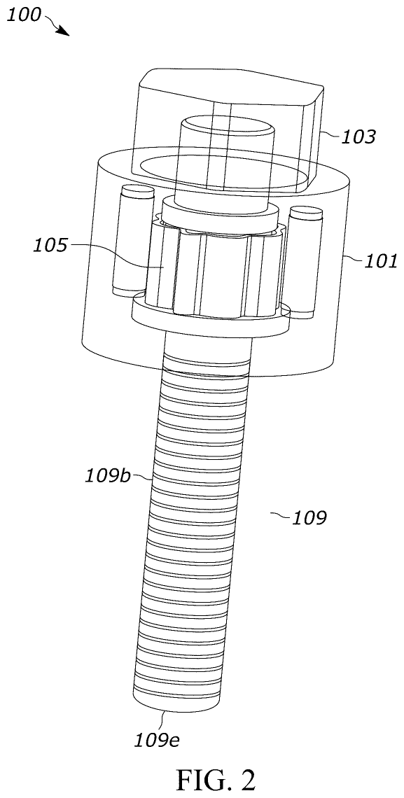

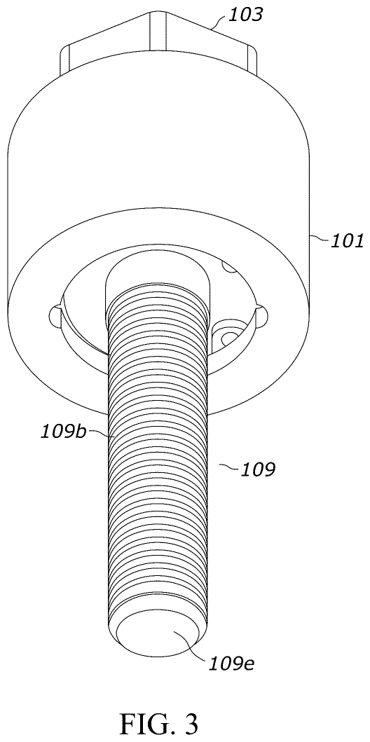

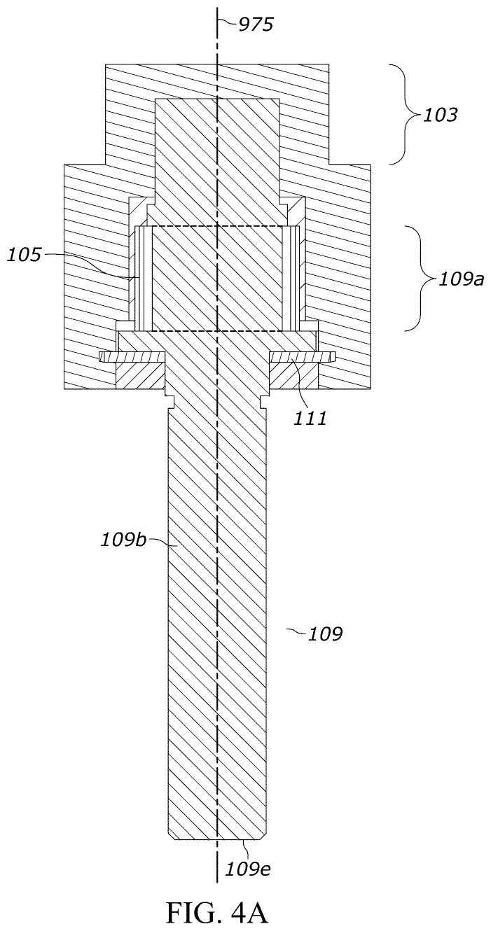

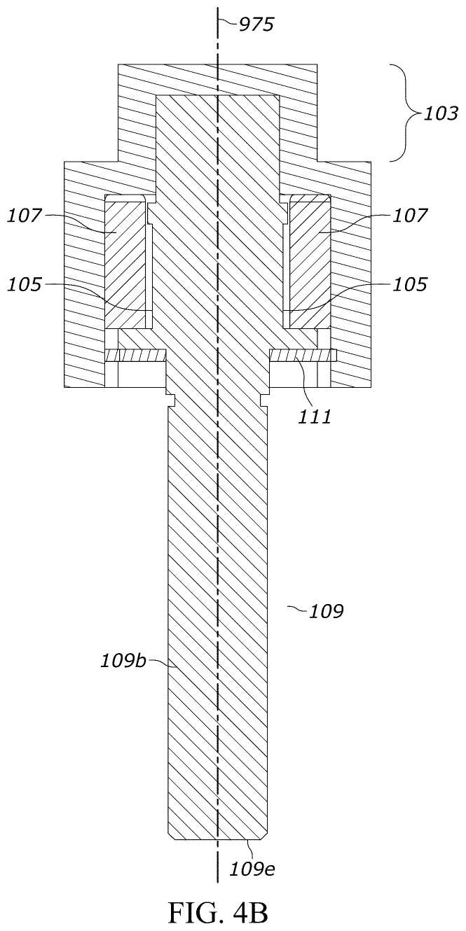

FIGS. 2-3 are perspective views of expander wave-spring torque limiting hardware for a threaded mechanical fastener 100 according to various embodiments disclosed herein. As illustrated in FIG. 2 the proximal end 109d of shank component 109 fits into a recess within the driver head 101. In the embodiment shown in FIG. 2 the recess extends up into the torque drive section 103 towards the proximal end of the torque drive section 103. The innermost part of the recess may be called an inner proximal driver-head surface. Typically, the proximal end 109d of shank component 109 rests against the inner proximal driver-head surface of the recess of driver head 101. This prevents the driver head 101 from pressing downward against the edges of expander wave-spring 105 and the dowel pins 107 as the threaded mechanical fastener 100 is tightened.

A retaining clip 111 may be provided to removably attach the driver head 101 to shank component 109. The retaining clip 111 fits within a groove on the inner surface of driver head 101. The type of retaining clip 111 shown in FIG. 1 can be installed and removed with snap-ring pliers. Other types of retention hardware may be implemented in the various embodiments aside from the retaining clip 111 shown in the figures. For example, one or more set screws may removably extend through the driver head 101 at a point below the spring support ledge 109c so as to hold the driver head 101 onto shank component 109. In embodiments without the retaining clip 111 the driver head 101 may be placed on the shank component 109 for tightening or loosening, and then (optionally) removed once shank component 109 is sufficiently tightened or loosened. ma

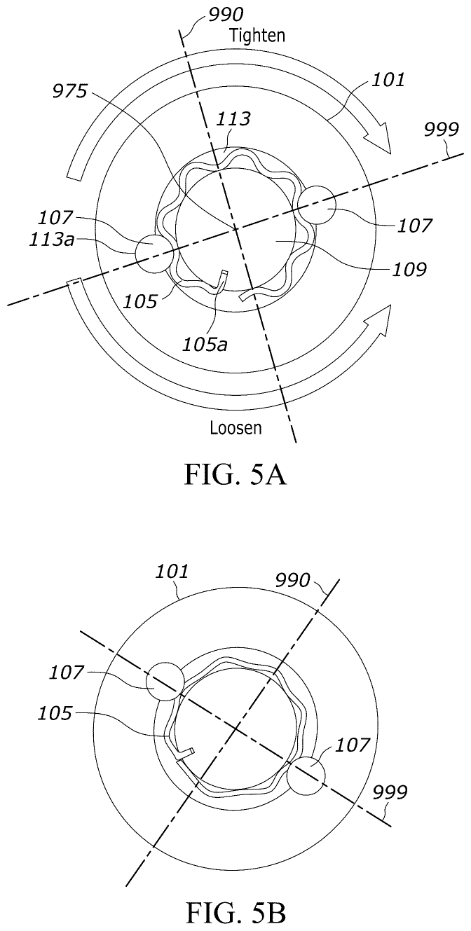

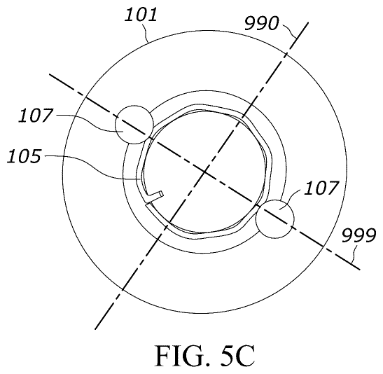

FIGS. 4A-B are cross-sectional views of expander wave-spring torque limiting hardware for a threaded mechanical fastener 100 according to various embodiments disclosed herein. FIG. 4A is the cross-sectional view taken at line 990 of FIG. 5A. FIG. 4B is the cross-sectional view taken at line 999 of FIG. 5A. The cross-sectional view of FIG. 4B bisects dowel pins 107.

Driver head 101 is configured with spring cavity 113 of sufficient size to hold expander wave-spring 105 and the dowel pins 107. The spring cavity 113 is typically concentric to the cylindrical shaped surface of driver head 101. Dowel recesses 113a are formed withing the spring cavity 113 of sufficient size and shape to accept insertion of a dowel pin 107 into each one. The orientation of expander wave-spring 105 and dowel pins 107 within the cavity of driver head 101 is illustrated in FIGS. 5A-B.

Retaining clip 111 can be seen in FIGS. 4A-B seated within a groove on the inner surface of driver head 101. Expander wave-spring 105 is shown in FIGS. 4A-B positioned around shank component 109 at the spring shaft section 109a. FIG. 4B and FIGS. 5A-B each depict dowel pins 107 positioned outside expander wave-spring 105. In some embodiments the dowel pins 107 may be positioned inside expander wave-spring 105 in recesses created in the shank component 109. In such embodiments the expander wave-spring 105 is secured to the inner surface of driver head 101 rather than being secured to the shank component 109 as shown in FIGS. 5A-B.

FIGS. 5A-B are cross-sectional top views of an expander wave-spring torque limiting hardware for a threaded mechanical fastener 100 according to various embodiments disclosed herein. The view of FIG. 5A cuts through driver head 101, expander wave-spring 105, dowel pins 107 and shank component 109. Spring cavity 113 is formed within driver head 101. The spring cavity 113 receives the shank component 109 up through its center space until the proximal end 109d of shank component 109 rests against the inner proximal driver-head surface of the recess of driver head 101, as shown in FIGS. 4A-4B. The expander wave-spring 105 also fits within the spring cavity 113, and is positioned around the spring shaft section 109a of shank component 109. As such, the expander wave-spring 105 is located within spring cavity 113 between the spring shaft section 109a and an inner surface of driver head 101.

The intersection of lines 990 and 999 is at the center point of shank component 109. Lines extending outward from the center point are said to extend radially from shank component 109. Expander wave-spring 105 has ridges that extend radially outward from spring shaft section 109a of shank component 109, which may be formed as a series of alternating concave and convex regions. The ridges are said to extend outward from the rotational center line 975 of the expander wave-spring 105. The rotational center line 975 of the expander wave-spring 105 is the center point of the spring and coincides with the intersection of lines 990 and 999 as shown in the figure. FIG. 5A depicts eight ridges on the expander wave-spring 105. Some implementations may have an expander wave-spring 105 with fewer ridges (e.g., seven ridges or six ridges). In the illustrated example, the expander wave-spring 105 may not extend entirely around the shank component 109, although a total arc length of the expander wave-spring 105 may exceed the perimeter of the shank component 109. For example, an end of the expander wave-spring 105 may be spaced apart from the spring anchor end 105a. In some implementations the expander wave-spring 105 does not extend as far around the shank component 109 as is shown in the embodiment depicted in FIG. 5A (e.g., there is a greater gap between the end of the expander wave-spring 105 and the spring anchor end 105a). It is preferable that the expander wave-spring 105 have enough ridges to extend at least halfway around the shank component 109 so that dowel pins 107 on opposite sides of the shank component 109 can each be received within a trough between two of the ridges.

The expander wave-spring 105 is typically a single turn spring—that is, the expander wave-spring 105 loops around spring shaft section 109a one time—or slightly less than, or greater than, one time. A multi-turn spring would loop around spring shaft section 109a multiple times. Typically, the expander wave-spring 105 extends slightly less than once around the spring shaft section 109a. In this way, as more force is applied, causing the ridges of expander wave-spring 105 to flatten down and the spring to extend further around the spring shaft section 109a, the expander wave-spring 105 does not double up on itself—that is, extend more than once around the shaft section 109a.

Dowel pins 107 fit within dowel recesses formed in the inner surface of driver head 101 within the spring cavity 113. The dowel recesses are configured to receive dowel pins 107, holding them in place extending radially inward into the spring cavity 113 while they make contact with expander wave-spring 105. FIGS. 5A-B depict two dowel pins 107. Some embodiments may have three or more dowel pins 107. Another embodiment has only one dowel pin 107. However, it is preferable to have at least two dowel pins 107 to balance the lateral force created between the dowel pins 107 and the expander wave-spring 105.

The distance between the innermost portion of each dowel pin 107 (closest to rotational center line 975) and the surface of spring shaft section 109 a of the shank component 109 is at least slightly greater than the thickness of expander wave-spring 105—e.g., at least a distance of the expander wave-spring 105 thickness plus 0.1 inch or more. This allows the dowel pins 107 to push on an adjacent ridge of expander wave-spring 105 and flatten out the expander wave-spring 105 to some extent as clockwise torque (rotational force) is applied to the torque drive section 103 to tighten the threaded mechanical fastener 100. In FIG. 5A the expander wave-spring 105 is fully contracted in the position as if counter-clockwise torque is being applied in order to loosen the threaded mechanical fastener 100.

As clockwise torque is applied to torque drive section 103 the expander wave-spring 105 flattens out and begins to stretch around spring shaft section 109a because spring anchor end 105a of expander wave-spring 105 is anchored to spring shaft section 109a of the shank component 109. In other words, a radius of curvature of the concave and convex sections of the expander wave-spring 105 may increase so that the expander wave-spring 105 may extend a greater distance around the perimeter of the shank component 109 (see e.g., FIG. 5B). FIG. 5C depicts expander wave-spring 105 in a fully expanded (stretched) position due to clockwise torque being applied to torque drive section 103 in order to tighten the threaded mechanical fastener 100. As more torque is applied, the expander wave-spring 105 stretches further around the spring shaft section 109a and flattens out more until the maximum fastener torque limit is reached. Upon reaching the maximum fastener torque limit the dowel pins 107 pass by the adjacent ridges of expander wave-spring 105 that they were pushing against.

Applying rotational force to driver head 101 causes torque to be applied to the shank component 109. The rotational force applied to driver head 101 is passed to the shank component 109 via one or more of the dowel pins 107 and via the expander wave-spring 105 which is affixed to spring shaft section 109a of the shank component 109. Due to friction between the components, and possibly other losses, the torque applied to shank component 109 is slightly less than rotational force applied to driver head 101. The torque applied to shank component 109 may be called tightening-torque.

Applying counter-clockwise rotational force to torque drive section 103 loosens the threaded mechanical fastener 100. Since spring anchor end 105a of expander wave-spring 105 is anchored to spring shaft section 109a of the shank component 109, the expander wave-spring 105 cannot rotate about shank component 109 causing the expander wave-spring 105 to bunch up within spring cavity 113. This, in turn, passes the counter-clockwise rotational force to the threaded mechanical fastener 100 to aid in loosening it.

The term “torque” is used herein in the explanation of this disclosure. Torque—which may also be called rotational force—is the force that causes an object to rotate or twist around an axis. It may be calculated by multiplying the force applied to the object by the distance from the application point to the center of the rotation axis. The phrase “torque limiting hardware” used throughout this disclosure of the various embodiments means the same and is interchangeable with the phrase “torque limiting apparatus.” The term “rotational fastener” is used in this disclosure of the various embodiments. A rotational fastener is any type of fastener that tightens and/or loosens in response to the application of rotation force. A bolt (that screws into a nut) is an example of a rotational fastener. A sheet metal screw, a wood screw and a lag bolt are three other examples of rotational fasteners.

The phrase “maximum fastener torque limit” is used herein in the explanation of this disclosure. Tightening a rotational fastener results in an increased amount of rotational force (i.e., torque) being applied to the rotational fastener. Upon reaching the maximum fastener torque limit of a torque limiting apparatus, as disclosed herein, the dowel pins begin to pass by the ridges of the expander wave-spring. In this way, once the maximum fastener torque limit is reached the dowel pins slip by the ridges of the expander wave-spring and no longer cause the rotational fastener to tighten.

The word “receive” is used is used herein in the explanation of this disclosure. A first mechanical component that “receives” a second component means that the second component is fit into a recess, hole, groove or shaped surface of the first component. The second component need not be fit entirely into the first component to be “receive.” That is, the second component may be received in the first component with part of the second component exposed, or sticking out of, the first component. For example, an appropriately sized threaded nut can receive a male threaded bolt. Also, a dowel recess 113a formed in an inner surface of the spring cavity 113 of driver head 101 can receive a dowel pin 107.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A wave-spring torque limiting apparatus for a rotational mechanical fastener, comprising:
a driver head including a spring cavity formed within the driver head and an inner proximal driver-head surface within the driver head;
a torque drive section configured as part of the driver head;
a wave-spring element curled around a rotational center line comprising a plurality of ridges extending in a radial direction outward from the rotational center line;
at least one dowel pin;
wherein the wave-spring element is positioned within the spring cavity around a shank component; and
wherein the shank component includes a proximal shank-end and a threaded section, the proximal shank-end being positioned to extend into the spring cavity.

2. The wave-spring torque limiting apparatus of claim 1, wherein one end of the wave-spring element is attached to the shank component; and
wherein applying rotational force to the driver head causes tightening-torque to be applied to the shank component.

3. The wave-spring torque limiting apparatus of claim 2, wherein the at least one dowel pin is a plurality of dowel pins.

4. The wave-spring torque limiting apparatus of claim 3, the apparatus further comprising:
a plurality of dowel recesses positioned on an inner surface of the spring cavity, each of the plurality of dowel recesses being shaped to receive a respective one of the plurality of dowel pins;
wherein each of the plurality of dowel pins is cylindrical, the wave-spring element of the apparatus further comprising a plurality of troughs, wherein each of the plurality of troughs is formed between adjacent ones of the plurality of ridges of the wave-spring element; and
wherein the rotational force applied to the driver head is passed to the shank component via the plurality of dowel pins via the wave-spring element.

5. (canceled)

6. (canceled)

7. The wave-spring torque limiting apparatus of claim 2,
wherein the torque drive section is hex shaped;
wherein the torque drive section is sized to be driven by a combination wrench;
wherein the threaded section of the shank component comprises male threads configured to screw into a female threaded component; and
wherein applying clockwise rotational force to the driver head causes the shank component to screw into the female threaded component.

8. (canceled)

9. (canceled)

10. The wave-spring torque limiting apparatus of claim 1, wherein the proximal shank-end of the shank component rests against the inner proximal driver-head surface in a recess of driver head.

11. The wave-spring torque limiting apparatus of claim 2, wherein the at least one dowel pin includes a first dowel pin and a second dowel pin, and the plurality of ridges includes a first ridge and a second ridge;
wherein the first and second ridges each extending upward from a minimum height to a ridge height.

12. The wave-spring torque limiting apparatus of claim 11, wherein applying the rotational force to the driver head causes the first dowel pin to push against the first ridge, transferring the rotational force to the shank component, wherein the rotational force is a first rotational force, and wherein the first ridge flattens in response to the first rotational force and contact by the first dowel pin.

13. (canceled)

14. The wave-spring torque limiting apparatus of claim 12, wherein applying a second rotational force to the shank component causes the first dowel pin to pass by the first ridge; and
wherein the second rotation force is greater than the first rotational force;
wherein the second rotational force is a maximum fastener torque of the torque limiting apparatus;
wherein removing all rotational force from the shank component causes the first ridge to rise to the ridge height;
wherein the first rotational force and the second rotational force are applied in a clockwise direction to tighten the threaded section of the shank component; and
wherein applying a third rotational force in a counter-clockwise direction results in the first dowel pin coming into contact with the second ridge causing the threaded section of the shank component to loosen.

15.-18. (canceled)

19. A wave-spring torque limiting apparatus for a rotational mechanical fastener, comprising:
a driver head including a spring cavity formed within the driver head;
a shank component disposed within the driver head;
a wave-spring element disposed within the spring cavity and extending at least partially around a perimeter of the shank component, wherein,
the wave-spring element includes a series of alternating concave regions and convex regions, and
the wave-spring element includes a fixed end coupled to an outer surface of the shank component and a free end spaced apart from the fixed end;
a first dowel pin disposed in one of the concave regions; and
a second dowel pin disposed in another one of the concave regions;
wherein applying first rotational force to the driver head in a first rotational direction causes tightening-torque to be applied to the shank component, and wherein a radii of curvature of the concave regions and convex regions are configured to increase so that the wave-spring element stretches around the perimeter of the shank component; and wherein applying second rotational force to the driver head in a second rotational direction causes loosening-torque to be applied to the shank component, and wherein the radii of curvature of the concave regions and convex regions are configured to decrease so that the free end moves away from the fixed end of the wave-spring element.

20. The wave-spring torque limiting apparatus of claim 19, the apparatus further comprising:
a plurality of dowel recesses positioned on an inner surface of the spring cavity, each of the plurality of dowel recesses being shaped to receive a respective one of the plurality of dowel pins.

21. The wave-spring torque limiting apparatus of claim 19, wherein applying the rotational force to the driver head in the first rotational direction causes the first dowel pin to push against a convex region, transferring the rotational force to the shank component, and wherein the convex region flattens in response to the first rotational force and contact by the first dowel pin.

22. The wave-spring torque limiting apparatus of claim 19, wherein applying the rotational force to the driver head in the second rotational direction causes the first dowel pin to push against a convex region, transferring the rotational force to the shank component, and wherein the radius of curvature of the convex region increases in response to the second rotational force and contact by the first dowel pin.

23. The wave-spring torque limiting apparatus of claim 19, wherein the torque drive section is hex shaped; and
wherein the torque drive section is sized to be driven by a combination wrench.

24. The wave-spring torque limiting apparatus of claim 19 wherein the wave-spring element is disposed between the shank component and the first dowel pin.

25. A wave-spring torque limiting apparatus for a rotational mechanical fastener, comprising:
a shank component coupled to a driver head;
a dowel disposed within a cavity of the driver head;
a wave-spring element disposed within the cavity between the shank component and the dowel, the wave-spring element having a first end fixed to the shank component and a second end spaced apart from the fixed end around a perimeter of the shank component;
wherein the wave-spring element is movable between a first position configured to distribute a tightening torque to the shank component and a second position configured to limit the tightening torque being applied to the wave-spring element; and
wherein a spacing between the first end and the second end decreases as the wave-spring element moves between the first position and the second position.

26. The wave-spring torque limiting apparatus of claim 25, wherein the driver head includes a torque drive section is hex shaped; and
wherein the torque drive section is sized to be driven by a combination wrench.

27. The wave-spring torque limiting apparatus of claim 25 or claim 26, wherein the wave-spring element includes a series of alternating convex regions and concave regions, and wherein the dowel is received in a concave region, and wherein applying the tightening torque to the driver head causes the first dowel pin to push against a convex region.

28. (canceled)

29. The wave-spring torque limiting apparatus of claim 27, wherein a radius of curvature of the convex sections increases as the wave-spring element moves from the first position to the second position.

30. The wave-spring torque limiting apparatus of claim 27, wherein the second end at least partially overlaps the first end in the second position.
